(19) United States
(12) Patent Application Publication
(10) Pub. No.: US 2019/0052117 A1
(43) Pub. Date: Feb. 14, 2019

(54) WIRELESS POWER TRANSMITTER TO RECEIVER COMMUNICATION DURING POWER TRANSFER PHASE

(71) Applicant: Integrated Device Technology, Inc., San Jose, CA (US)

(72) Inventor: Detelin Martchovsky, Fremont, CA (US)

(21) Appl. No.: 16/100,544

(22) Filed: Aug. 10, 2018

Related U.S. Application Data
(60) Provisional application No. 62/544,649, filed on Aug. 11, 2017.

(51) Int. Cl. H02J 7/02; H02J 50/80; H02J 50/10

(52) U.S. Cl. CPC H02J 7/025; H02J 50/10; H02J 50/80

(57) ABSTRACT

In accordance with some embodiments of the present invention a method of communicating with a wireless power receiver during a power transfer phase is presented. The method includes receiving from the wireless power receiver an receive packet; and transmitting an transmit packet within a time after receipt of the receive packet, the transmit packet being other than an acknowledgment packet. A method of communicating with a wireless power transmitter during a power transfer phase includes transmitter to the wireless power transmitter a receive packet; enabling a decoder within a time period; and if a start bit of a transmit packet is received, receiving the transmit packet, wherein the transmit packet is other than an acknowledgment packet.

### RELATED APPLICATIONS

The present application claims priority to U.S. Provisional Application No. 62/544,649 filed Aug. 11, 2017, the contents of which is incorporated herein by reference in their entirety for all purposes.

### TECHNICAL FIELD

Embodiments of the present invention are related to wireless power systems and, specifically, to communications between.

### DISCUSSION OF RELATED ART

Typically, a wireless power system includes a transmitter coil that is driven to produce a time-varying magnetic field and a receiver coil that is positioned relative to the transmitter coil to receive the power transmitted in the time-varying magnetic field. In addition to transmitting wireless power between the transmitter and the receiver, the transmitter and receiver may also communicate. Although some systems may utilize a separate communications path between the wireless power receiver and the wireless power transmitter, may of the standards provide for a communications patent between the transmitter and receiver using the wireless power signal. For example, the wireless power transmitter can use a frequency shift-keying (FSK) modulation scheme to communicate data to the receiver and the receiver can provide amplitude modulation (ASK) to transmit data to the transmitter.

There are multiple standards for wireless transmission of power, including the Alliance for Wireless Power (A4WP) standard and the Wireless Power Consortium standard (or Qi Standard). Under the A4WP standard, for example, up to 50 watts of power can be inductively transmitted to multiple charging devices in the vicinity of coil 106 at a power transmission frequency of around 6.78 MHz. Under the WPC specification, a resonant inductive coupling system is utilized to charge a single device at the resonance frequency of the device. In the WPC standard, the receive coil is placed in close proximity with the transmit coil while in the A4WP standard, coil 108 is placed near coil 106 along with other coils that belong to other charging devices.

Although these standards provide for communications protocols between the transmitter and the receiver, there is a need for better communication between the transmitter and the receiver.

### SUMMARY

In accordance with some embodiments of the present invention a method of communicating with a wireless power receiver during a power transfer phase is presented. The method includes receiving from the wireless power receiver an receive packet; and transmitting an transmit packet within a time after receipt of the receive packet, the transmit packet being other than an acknowledgment packet.

A method of communicating with a wireless power transmitter during a power transfer phase includes transmitter to the wireless power transmitter a receive packet; enabling a decoder within a time period; and if a start bit of a transmit packet is received, receiving the transmit packet, wherein the transmit packet is other than an acknowledgment packet.

These and other embodiments are further discussed below with respect to the following figures.

### BRIEF DESCRIPTION OF THE DRAWINGS

FIG. 1 illustrates a wireless power transmission system.

FIGS. 2A and 2B illustrate packet formats for transmission of data between a wireless power transmitter and a wireless power receiver.

FIG. 3 illustrates a state diagram for operation of wireless power system in conformance with the Qi standard.

FIG. 4 illustrates a feedback loop according to the Qi standard during a power transfer phase.

FIG. 5 illustrates communications between a transmitter and a receiver according to the Qi standard during the power transfer phase.

FIG. 6 illustrates communications between the transmitter and the receiver according to embodiments of the present invention during the power transfer phase.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

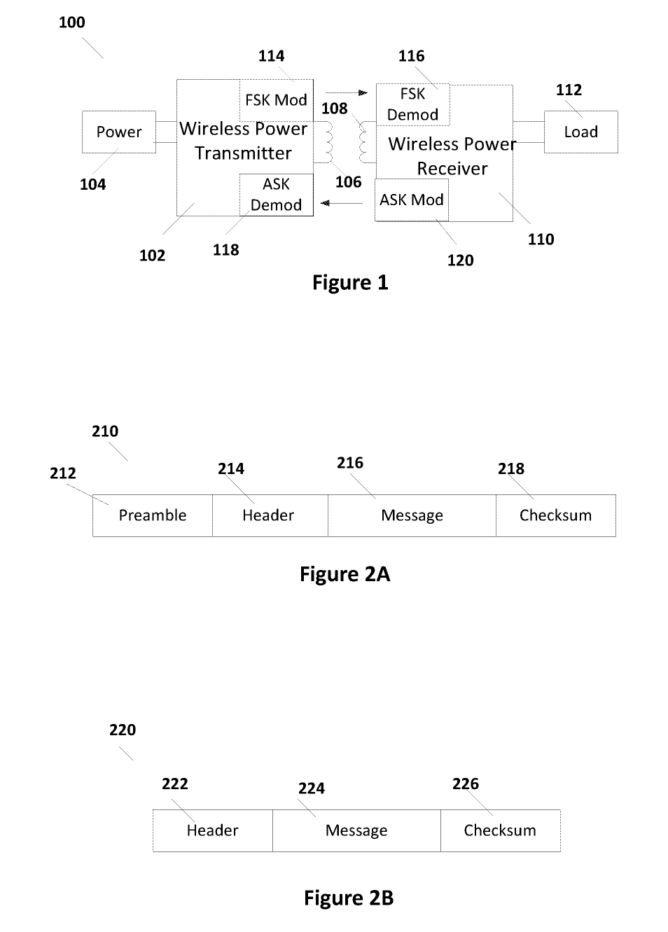

FIG. 1 illustrates a system 100 for wireless transfer of power. As illustrated in FIG. 1, a wireless power transmitter 102 drives a coil 106 to produce a time-varying magnetic field. A power supply 104 provides power to wireless power transmitter 102. Power supply 104 can be, for example, a battery based supply or may be powered by alternating current, for example 120V at 60 Hz. Wireless power transmitter 102 drives coil 106 at, typically, a range of frequencies according to one of the wireless power standards. However, this discussion is applicable to any range of driving frequencies and power levels where it is practical to transfer power and/or information by means of magnetic coils between a wireless power transmitter and a wireless power receiver. FIG. 1 depicts a generalized wireless power system 100 that operates under any of these standards.

As is illustrated in FIG. 1, the magnetic field produced by transmission coil 106 induces a current in receiver coil 108, which results in power being received in a receiver 110. Receiver 110 receives the power from coil 108 and provides power to a load 112, which may be a battery charger and/or other components of a mobile device. Receiver 110 typically includes rectification to convert the received AC power to DC power for load 112.

Wireless power transmitter 102 can further include one or more processors as well as memory, including volatile and non-volatile memory, that can store data and operating instructions. The processor is coupled to circuitry to monitor and control the wireless power signal generated at transmit coil 106. Similarly, wireless power receiver 110 includes one or more processors as well as memory, including volatile and non-volatile memory, that can store data and operating instructions. The processor in wireless power receiver 110 is coupled to circuitry to receive and process the wireless power received at receive coil 108.

As is further illustrated in FIG. 1, wireless power transmitter 102 and wireless power receiver 110 can communicate using the wireless power signal transmitted between transmit coil 106 and receive coil 108. As is illustrated in FIG. 1, wireless power transmitter includes a frequency-shift key (FSK) modulator 114 that modulates the frequency of the wireless power signal in order to transmit data to wireless power receiver 110. As is further illustrated, wireless power receiver 116 includes an FSK demodulator 116 that receives and recovers the data transmitted by wireless power transmitter 102. Similarly, an amplitude shift-keying (ASK) modulation 120 can transmit data to transmitter 102 by backscatter modulation of the received power signal load. As is illustrated in FIG. 1, amplitude modulated data is received and recovered in ASK demodulator 118.

In the WPC standard, during wireless power transmission the wireless power receiver provides periodic updates to the transmitter indicating whether the transmitter should increase or decrease the power. However, currently there is no provision to allow the transmitter to provide packets if not prompted by the receiver during the wireless power phase. For purposes of example, the WPC standard is referred to in this disclosure although the invention is applicable to other transmission systems as well. In particular, Wireless Power Consortium, Qi specification 1.2.3, released February 2017, which is herein incorporated by reference in its entirety, is referred to in this disclosure. In particular Part 1, Section 5, of the Qi standard, which described the information interface of adhering devices, is discussed.

FIGS. 2A and 2B illustrate data packets 210 and 220, respectively, for data sent between wireless power transmitter 102 and wireless power receiver 110. FIG. 2A illustrates the format of data packet 210 transmitted as an ASK modulated signal from wireless power receiver 110 to wireless power transmitter 102. As illustrated in FIG. 2A, the format of data packet 210 includes a preamble 212, header 214, message 216, and checksum 218. Preamble 212 consists of a minimum of 11 bits and a maximum of 25 bits, all set to “1”. Header 214, message 216, and checksum 218 consist of three or more bytes encoded according to the packet type. Header 214 provides the size and size of message 216. Message size can range between 1 and 20 bytes, including a variety of message types that are designated as proprietary. Other types of messages include signal strength, end power transfer, control error, 8-bit received power, charge status, power control hold-off, general, renegotiate, specific request, FOD status, 24-bit received power, configuration, WPID, identification, and extended identification. Each of the message types are defined in the WPC standard. Each byte is transmitted as 11-bit serial format that includes a start bit, 8 data bits, a parity bit, and a stop bit. The types of messages are further explained in the Qi standard in Part 1, Section 5.2.3.

As is further illustrated in FIG. 2B, packet structure 220, which is transmitted from transmitter 102 to receiver 110, includes a header 222, a message 224, and a checksum 226. As with receiver packet 210, header 22 indicates packet type and the size of message 224. In a negotiation phase, packet 220 can include packets for transmitter identification and transmitter capability data as well as proprietary data. However, response packets can include an acknowledge message (ACK), a not-acknowledge message (NAK), or a not-defined message (ND if the packet received from receiver 110 is unrecognized or is invalid.

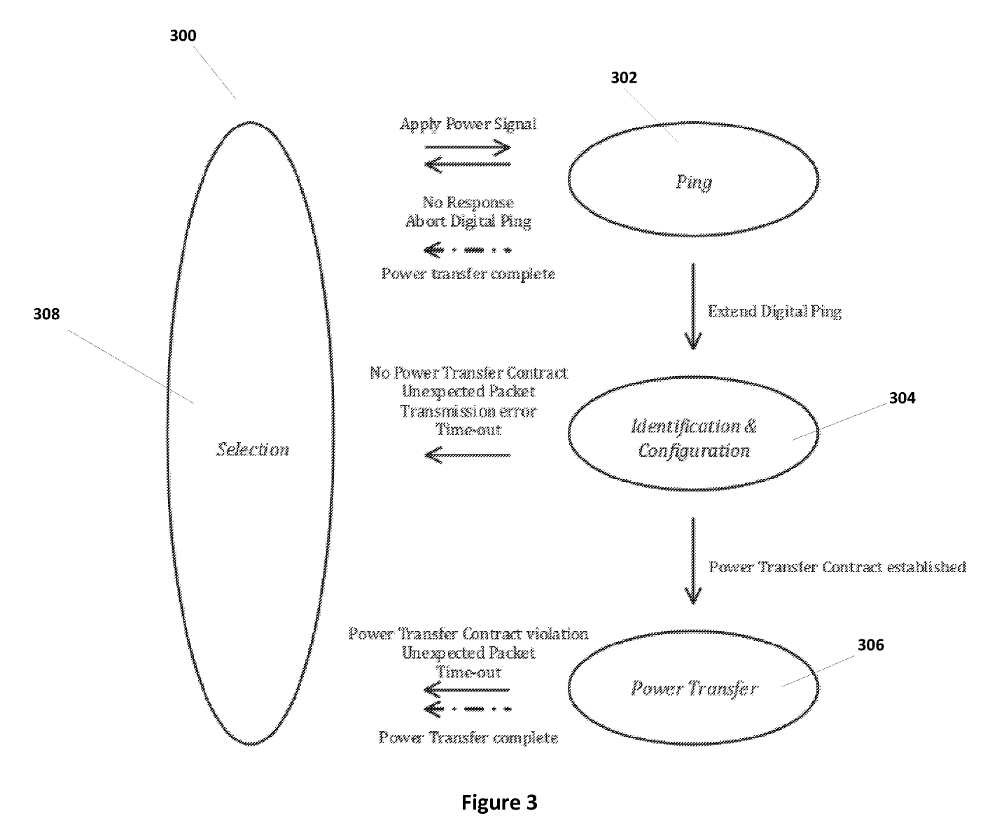

FIG. 3 illustrates a typical state function diagram 300 for operation of the wireless power system 100 illustrated in FIG. 1 according to the WPC standard. As illustrated in FIG. 3, according to the WPC standard operation of the system includes operation in a state function that includes a selection phase 308, a ping phase 302, an identification and configuration phase 304, and a power transfer phase 306. In some examples, a foreign object detection system can include a negotiation phase, a calibration phase, and a renegotiation phase. However, for purposes of this discussion, discussion of the phases of the state function illustrated in FIG. 3 is sufficient.

In selection phase 308, wireless power transmitter monitors the interface for the placement and removal objects. In some cases, wireless power transmitter can differentiate between foreign objects and receivers placed within the field of transmitter coil 106. Selection phase is entered when receiver 110 indicates that a power transfer is complete, when transmitter 102 indicates a violation of a power transfer contract, or when there is no response to a ping generated in a ping phase 302. Selection phase 308 transitions to ping phase 302 when an object that may be a receiver 110 is detected.

In ping phase 302, wireless power transmitter 102 executes a digital ping and listens for a response. If power transmitter 102 discovers a power receiver 110, power transmitter 102 can extend the digital ping to maintain a power signal at the level of the digital ping. Function diagram 300 then proceeds to identification and configuration phase 304.

In the identification and configuration phase 304, power transmitter 102 identifies power receiver 110 and obtains configuration information such as the maximum amount of power that power receiver expects to supply to its output. Power transmitter 102 uses this information to create a power transfer contract, which limits several parameters that characterize the power transfer that will occur in power transfer phase 306.

In power transfer phase 306, power transmitter 102 provides power to receiver 110 according to the restrictions of the power transfer contract. During power transfer phase 306, receiver 110 provides a control error packet that instructs transmitter 102 to adjust power levels.

A typical operation sequence for wireless power transfer will work as following. First, in a low power standby mode, transmitter 102 may send out regular pings to determine the presence of a receiver 110. If a receiver 110 is detected, a digital ping in ping phase 302 may be provided that has sufficient energy to activate receiver 110. Receiver 110 can then provide a communications packet 210 regarding requested signal strength. Transmitter 102 can then maintain a power signal to move to the identification and configuration phase 304. In the configuration phase 304, receiver 110 sends data packets to transmitter 102 that can include the wireless power consortium (WPC) version and other data such as maximum required output power. After completing configuration phase 304, the system moves to power transfer phase 306. In power transfer phase 306, receiver 110 measures the rectified voltage and sends packet 210 that is an error packet such as a control error packet. The control error packet tells transmitter 102 to increase or decrease the transmitted power to control the transmitted power in such a way that there is sufficient voltage to maintain a stable output voltage. In addition, receiver 110 can regularly send a received power packet to transmitter 102. If transmitter 102 detects a difference between the received power value and its own transmitter power, transmitter 102 can shut down to ensure safety during power transfer. When receiver 110 no longer needs power (e.g., the battery at receiver 110 is fully charged), receiver 110 can send a signal packet to end power transfer.

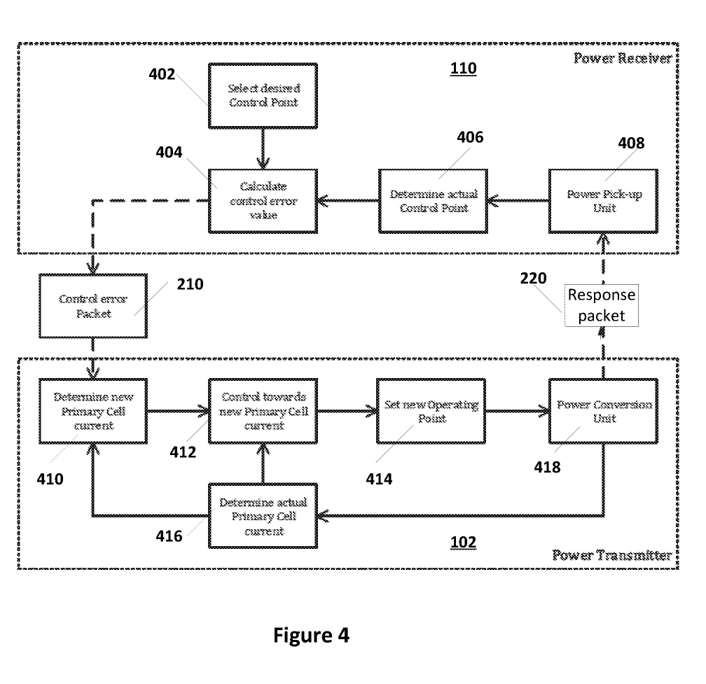

FIG. 4 illustrates system 100 operating in power transfer phase 306. As is illustrated in FIG. 4, receiver 110 and transmitter 102 are in communications throughout power transfer phase 306. Receiver 110 includes a power pick-up unit 408 that receives the wireless power signal from transmitter 102 and provides a power signal to determination box 406. In determination box 406, an actual control point is determined that indicates that actual power received at power pick-up unit 408. In block 402, the desired control point is determined based on operating parameters (e.g., load projections, temperature, and other parameters) of receiver 110. Block 404 receives the desired control point from block 402 and the actual control point from block 406 and determines a control error value.

The control error value is provided in packet 210, which is the control error packet, to transmitter 102. Transmitter 102 receives the control error packet 210 and, in block 410, determines a new coil current with which to drive transmit coil 106 to provide a new power control point for receiver 110. Block 410 receives input from block 416, which determines the actual primary coil current from a power conversion unit 418. Power conversion unit 418 provides current to transmit coil 106 according to parameters determined in block 414.

As illustrated in FIG. 4, the actual primary coil current from block 416 is provided to block 410, which also receives the control error from control error packet 210. Block 410 then calculates a new primary coil current and provides that to block 412. Block 412 compares the new primary coil current with the actual primary coil current and provides signals to block 414 to adjust the primary coil current towards the new primary coil current. The adjusted primary coil current is then provided to power conversion unit 418 to provide the adjusted primary coil current to produce wireless power for receiver 110. As is illustrated, a feedback loop formed by block 418, 416, 412, and 414 control the current through transmit coil 106 to reduce the control error value produced in block 404 to zero.

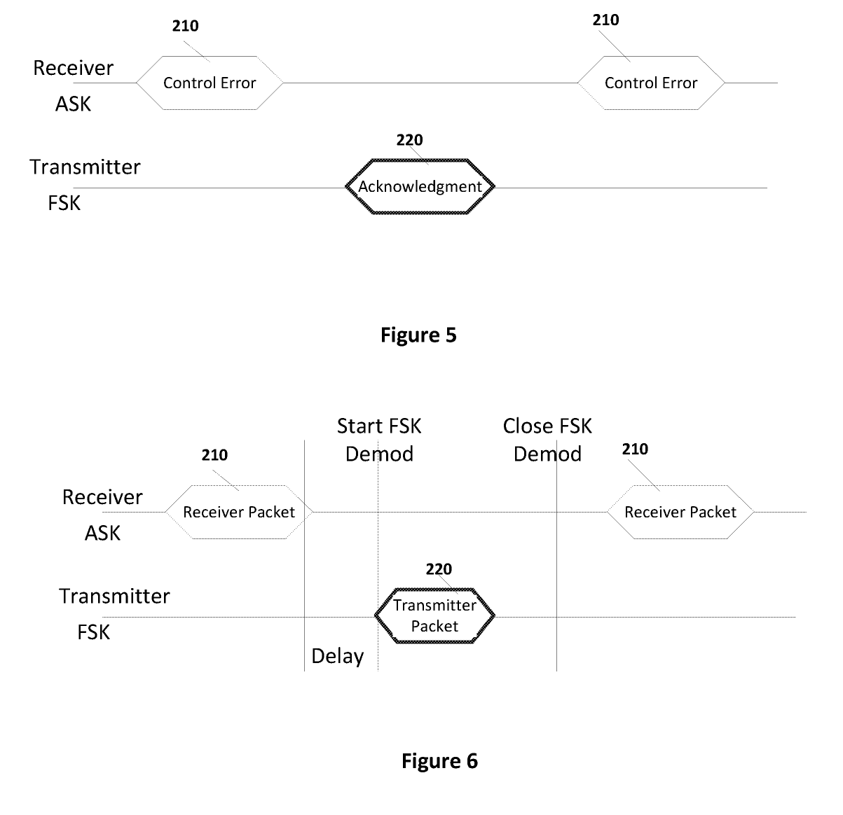

In addition to the feedback characteristics illustrated in FIG. 4, as is further illustrated transmitter 102 can provide a response packet 220 when control error packet 210 is received. FIG. 5 illustrates a communications sequence between receiver packets and transmit packets according to the Qi standard. As illustrated in FIG. 5, once a packet 210 is received by transmitter 102, it can send an acknowledgment 220. However, as discussed above, the response packet 220 from transmitter 102 is limited to an acknowledgment packet (ACK, NAK, or ND). Transmitter 102 may also terminate power upon receipt of an End Power Transfer packet, an unknown packet, or if a packet 210 is not received within a termination time of the first packet 210.

As discussed above, the current WPC specification does not have a provision to allow transmitter 102 to send packets 220 with anything other than an acknowledgment packet if not prompted to do so, which happens in only limited occasions. For a number of reasons, there is a need to allow packets to be sent after any packet 210 received from receiver 110 during Power Transfer phase 306 while keeping compatibility with the existing timing rules of the WPC standard. One example is if the environment of transmitter 102 changes and transmitter 102 then needs to communicate the changes to receiver 110, which may result in renegotiation of the power transfer contract. Another example is if transmitter 102 needs to authenticate receiver 110. In general, the need is to allow transmitter 102 to send information to receiver 110 during a Power Transfer phase, whether this information is a status report, request, or data as part of communication channel is great.

In some attempts to remedy this problem, receiver 110 may request status reports from the transmitter 102 on regular intervals, providing an opportunity for transmitter 102 to provide further information. In FIG. 5, for example, receiver packet 210 may be a request packet instead of a control error packet 210. Depending on the response, receiver 110 may initiate a renegotiation by activating configuration phase 304. Another approach is to allow transmitter 102 to stop power transfer and re-initiate the selection phase 308. In all cases the response of the system is slow and limited.

In accordance with embodiments of the present invention, a response packet 220 from transmitter 102 is more than the allowed acknowledgment packet. Instead, response packet 220 from transmitter 102, which is sent in response to a packet 210 received from receiver 110, can be any packet, including a status report, request, or data. Request packets, for example, can be used to enter a renegotiation of the power contract. Status report packets, for example, can report to receiver 110 various limitations that have been detected in transmitter 102.

From the point of view of transmitter 102, as illustrated in FIG. 6, during power transfer phase 306, transmitter 102 may start a packet after any received packet 210, as is illustrated in FIG. 6. The delay between the end of received packet 210 to the start of the transmit packet 220 can be between 3 ms and 10 ms. If the preceding receiver packet 210 was a Control Error Packet with value different than zero, transmitter 102 should ensure the Control Delay time limit is met, and transmitter 102 may start changing its power set point according the adjusted current value as illustrated in FIG. 4. All timing requirements from the WPC specification should be followed with the only exception of the delay between the end of a control error packet 210 to the start of the power change is the longer of the transmit packet 220 completion or the control delay requested during the ID & Configuration phase 304 that results in the current power contract.

From the point of view of receiver 110 during power transfer phase 306, receiver 110 enables its decoding process (for FSK decoding) no later than the earliest time, for example 3 ms, after the end of any ASK modulated receiver packet 210 being sent. In case no FSK Start bit is detected by receiver 110, receiver 110 may close the FSK decoding process not earlier than to allow decoding of first start bit sent with maximum delay, for example of 10 ms. In case of the FSK Start bit being detected, receiver 110 keeps receiving the transmit packet 220 until completion or an error is detected. In both cases, receiver 110 ensures the minimum timing required by the WPC specification is met before sending the next receive packet 210. In case the last receive packet 210 sent before detecting transmit packet 220 was a control error packet, receiver 110 delays the start of control by the longer of the calculated duration of transmit packet 220 or the control delay requested during the ID & Configuration phase 304.

The above detailed description is provided to illustrate specific embodiments of the present invention and is not intended to be limiting. Numerous variations and modifications within the scope of the present invention are possible. The present invention is set forth in the following claims.

What is claimed is:

1. A method of communicating with a wireless power receiver during a power transfer phase, comprising:
receiving from the wireless power receiver a receive packet; and
transmitting a transmit packet within a time period after receipt of the receive packet, wherein the transmit packet is other than an acknowledgment packet.

2. The method of claim 1, wherein the wireless power receiver enables decoding of the transmit packet within the time period.

3. The method of claim 1, wherein the transmit packet is a request packet.

4. The method of claim 3, wherein the request packet is a request for renegotiation.

5. The method of claim 1, wherein the transmit packet is a status report packet.

6. The method of claim 1, wherein the transmit packet is a data transfer packet.

7. The method of claim 1, wherein if the receive packet is a control error packet, the method further includes adjusting power transferred according to a control error transmitted in the control error packet.

8. The method of claim 1, wherein if the receive packet is an End Power Transfer Packet the method further includes terminating power transfer.

9. The method of claim 1, wherein timing requirements of the Word Power Consortium standard are met.

10. A method of communicating with a wireless power transmitter during a power transfer phase, comprising:
transmitter to the wireless power transmitter a receive packet;
enabling a decoder within a time period; and
if a start bit of a transmit packet is received, receiving the transmit packet, wherein the transmit packet is other than an acknowledgment packet.

11. The method of claim 10, wherein the time period starts at a delay time and closes after a second time period.

12. The method of claim 10, wherein the transmit packet is a request packet.

13. The method of claim 12, wherein the request packet is a request for renegotiation.

14. The method of claim 10, wherein the transmit packet is a status report packet.

15. The method of claim 10, wherein the transmit packet is a data transfer packet.

16. The method of claim 10, wherein if the receive packet is a control error packet, a second receive packet is transmitted within timing requirements of the World Power Consortium standard.

17. The method of claim 10, wherein timing requirements of the Word Power Consortium standard are met.
